(19) United States
(12) Patent Application Publication
(10) Pub. No.: US 2018/0339344 A1
(43) Pub. Date: Nov. 29, 2018

(54) SYSTEM AND METHOD FOR IN-SITU PROCESSING OF ADDITIVE MANUFACTURING MATERIALS AND BUILDS

(71) Applicant: Huntington Ingalls Incorporated, Newport News, VA (US)

(72) Inventors: John Walter Ralls, Yorktown, VA (US); Daniel John Hebert, Carrollton, VA (US); James Richard Brooks, Suffolk, VA (US); Brent William Blaha, Yorktown, VA (US); Garrett J. Sonnenberg, Yorktown, VA (US)

(21) Appl. No.: 15/935,220

(22) Filed: Mar. 26, 2018

Related U.S. Application Data
(60) Provisional application No. 62/509,910, filed on May 23, 2017.

(51) Int. Cl. B22F 3/24; B22F 3/105; B33Y 10/00; B33Y 30/00

(52) U.S. Cl. CPC B22F 3/24; B22F 3/1055; B22F 2003/1056; B33Y 30/00; B33Y 10/00

(57) ABSTRACT

An additive manufacturing (AM) apparatus includes a build chamber, a build platform disposed within the build chamber for supporting an AM build part therein, and a build material deposition device. The apparatus further includes an energization arrangement having at least one energization source. The energization arrangement is capable of, in a fusion energy operation, selectively applying energy to a layer of build material to fuse the build material to form a next-to-be-produced layer of the AM build part and, in a material processing operation, selectively applying energy to and processing the surface of a last-produced layer of the AM build part, the layer of build material, and/or a surface of the next-to-be-produced layer.

This application claims priority to U.S. Provisional No. 62/509,910, filed May 23, 2017, the complete disclosure of which is incorporated herein by reference.

### BACKGROUND OF THE INVENTION

This application relates generally to additive manufacturing methods and, more particularly, to the incorporation of directed energy material processing (DEMP) into AM build processes.

Additive manufacturing (AM) is the term given to processes for manufacturing three-dimensional components by progressively adding thin, substantially two-dimensional layers on a layer by layer basis. Each layer is made at a specified thickness and many layers are formed in a sequence with the two dimensional layer shape varying from layer to layer to achieve a desired three-dimensional component structure.

The additive nature of the process is in direct contrast to traditional “subtractive” manufacturing processes where material is removed to form the desired structure. AM processes have many inherent advantages over subtractive processes, including, in particular, the ability to build complex structures from digital models that may be difficult or impossible to form by traditional machining methods.

A unique aspect of an AM process is that it allows access, during manufacture, to what will be the internal structure of a monolithic part. The methods of the present invention take advantage of this access to effect changes in the layers of an in-work build part that result in enhanced structural characteristics of the final part.

### SUMMARY OF THE INVENTION

An illustrative aspect of the invention provides an additive manufacturing apparatus comprising a build chamber, a build platform disposed within the build chamber for supporting an AM build part therein, and a build material deposition device. The build platform is movable along a vertical axis to allow sequential positioning of the AM build part to position a surface of a last-produced layer of the AM build part at a horizontal build plane for addition of a next-to-be-produced layer thereto. The build material deposition device is configured for applying a layer of build material to the surface of a last-produced layer of the AM build part. The additive manufacturing apparatus further comprises an energization arrangement having at least one energization source, the energization arrangement being capable of, in a fusion energy operation, selectively applying energy to the layer of build material to fuse the build material to form the next-to-be-produced layer and, in a material processing operation, selectively applying energy to and processing at least one of the set consisting of the surface of a last-produced layer of the AM build part, the layer of build material, and a surface of the next-to-be-produced layer.

Another illustrative aspect of the invention provides a method of manufacturing an AM build part using an AM apparatus comprising a build chamber, a build platform, a fusion energization source configured for fusing a build material at a horizontal build plane within the build chamber, and a processing energization source. The method comprises positioning an upper surface of the build platform at the build plane, depositing a layer of the build material at the build plane, and applying energy by the fusion energization source to fuse a portion of the build material in a desired pattern to form a current layer of the AM build part. The method further comprises effecting a material processing operation on the current layer of the AM build part by using the processing energization source to apply energy to a surface of the current layer of the AM build part. The method may further comprise determining whether a next build part layer should be constructed, and, responsive to a determination that a next build part layer should be constructed, repositioning the build platform to position an upper surface of the current layer at the build plane and repeating the actions of depositing, applying, effecting, and determining.

### BRIEF DESCRIPTION OF THE DRAWINGS

The invention can be more fully understood by reading the following detailed description together with the accompanying drawings, in which like reference indicators are used to designate like elements, and in which:

FIGS. 1A, 1B, 1C, and 1D are schematic representations of the operation of a generic AM system;

FIGS. 2A and 2B are schematic illustrations of the application of directed energy material processing to a build part;

FIGS. 3A and 3B illustrate potential effects of the application of DEMP to a build part;

FIG. 4A is a graphical representation of the through-thickness stress state of a typical peened metal part;

FIG. 4B is a graphical representations of a through-thickness stress state of an AM/LMP build part;

FIG. 5 is a schematic representation of an AM system according to an embodiment of the invention;

FIG. 6 is a schematic representation of an AM system according to an embodiment of the invention;

FIG. 7 is a schematic representation of an AM system according to an embodiment of the invention;

FIG. 8 is a schematic representation of an AM system according to an embodiment of the invention;

FIG. 9 is a schematic representation of an AM system according to an embodiment of the invention;

FIG. 10 is a schematic representation of an AM system according to an embodiment of the invention;

FIG. 11 is a flow diagram of a method of additive manufacturing and material processing according to an embodiment of the invention; and

FIG. 12 is a flow diagram of a method of additive manufacturing and material processing according to an embodiment of the invention.

### DETAILED DESCRIPTION OF THE INVENTION

The present invention provides methods and apparatus for in-situ processing of additively manufactured components (e.g., etched, printed, scribed, formed, printed, or compacted metallic powder components, etc.). The methods of the invention allow in-situ mitigation of process and material-related residual stress formation/abatement, internal rearrangement of microstructure, alteration of surface profiling/finish, defect correction, altering material properties, and/or part geometry formation during additive manufacturing. The methods of the invention also provide for localized microforming to alter or correct the topology and/or microstructure produced by the additive process. The methods of the invention use directed energy input devices to perform microforming and micro-structural alteration of an additively manufactured layer (and subsequently built layers). The methods can be applied with or without a tamping layer. For example, the methods can be applied under inert gas conditions, in air, or under vacuum.

As used herein, the term “directed energy” refers to any form of directable, concentrated electromagnetic or ultrasonic energy or beams of atomic or subatomic particles. While the invention will be described in connection with particular embodiments and manufacturing environments, it will be understood that the invention is not limited to these embodiments and environments. On the contrary, it is contemplated that various alternatives, modifications and equivalents are included within the spirit and scope of the invention as described.

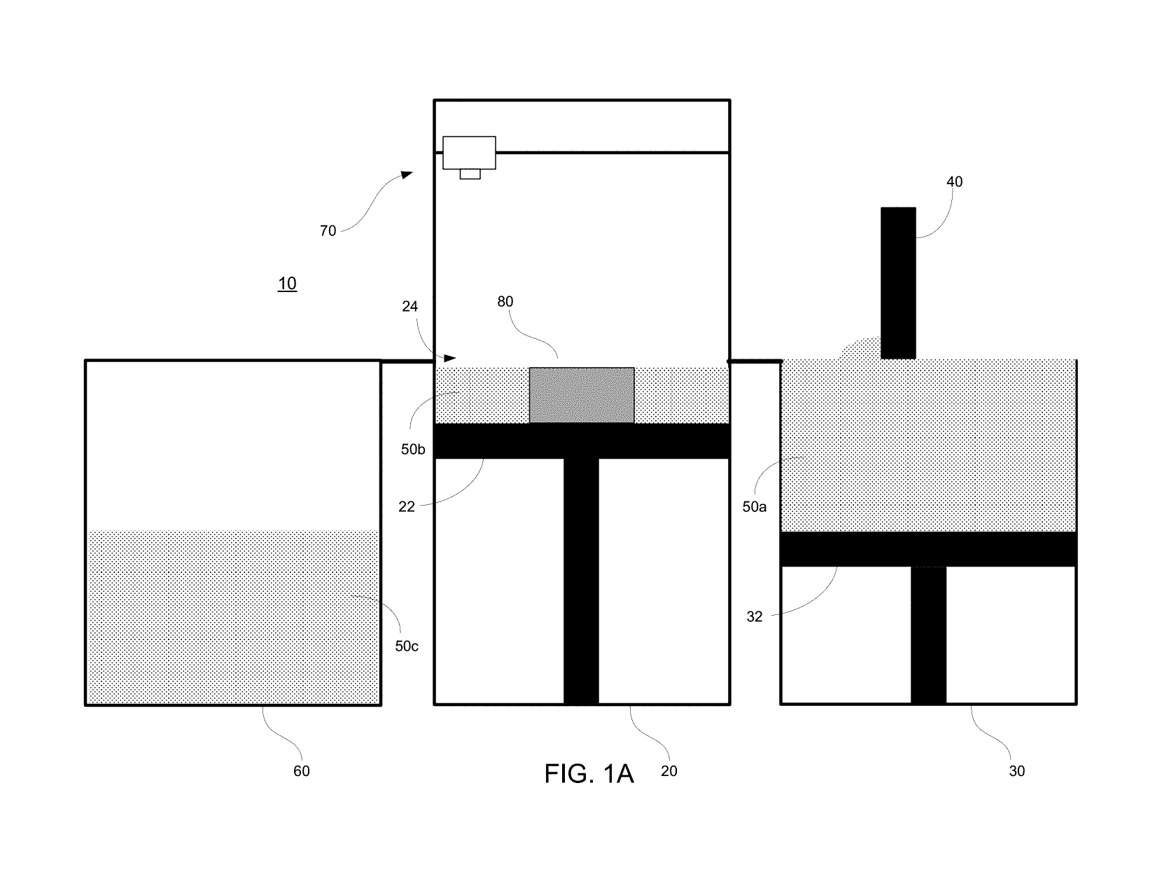

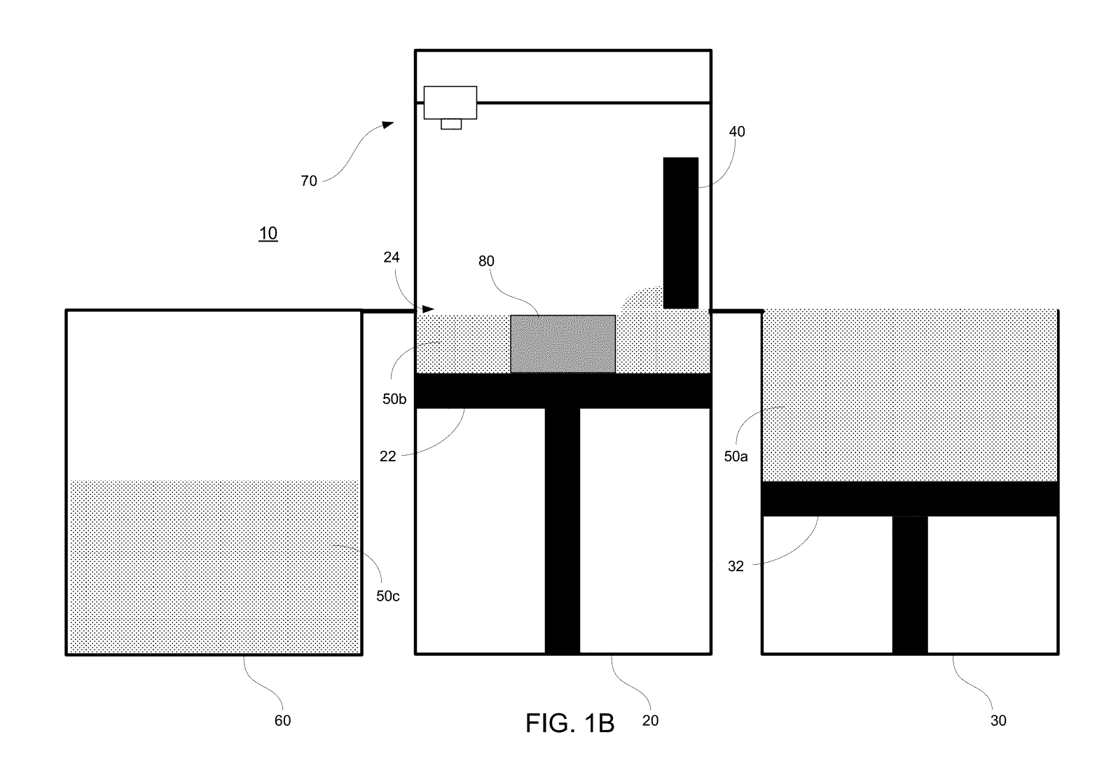

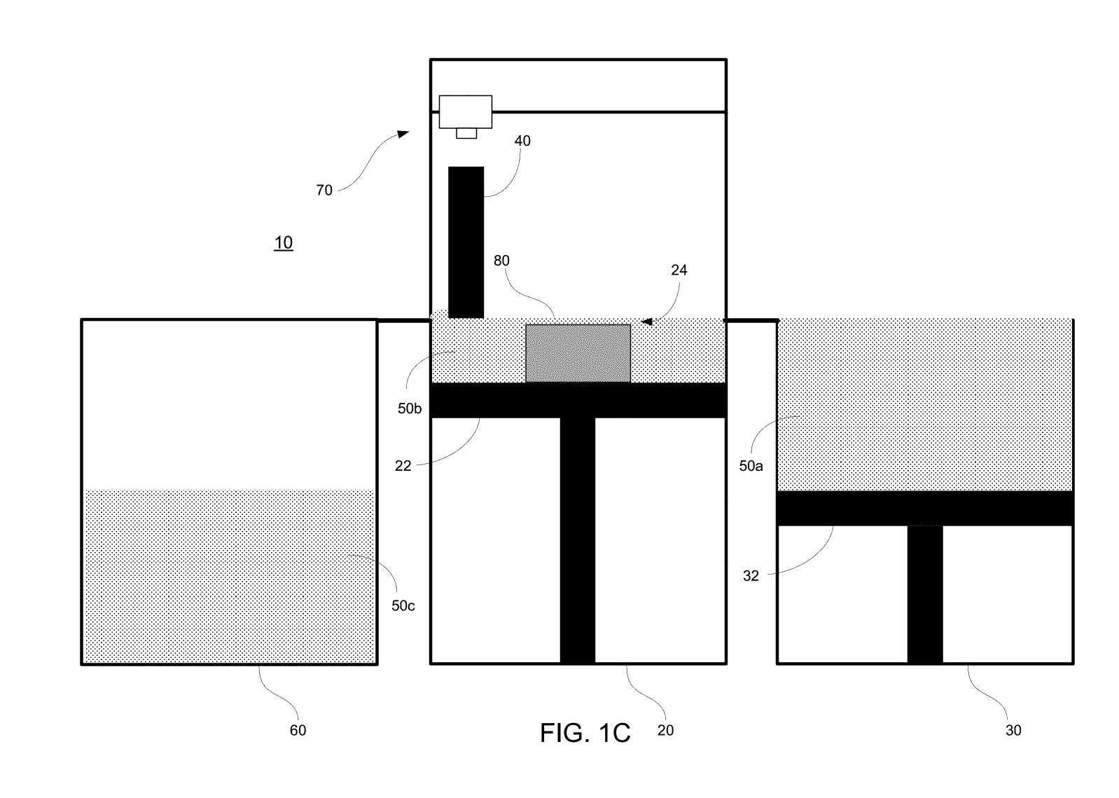

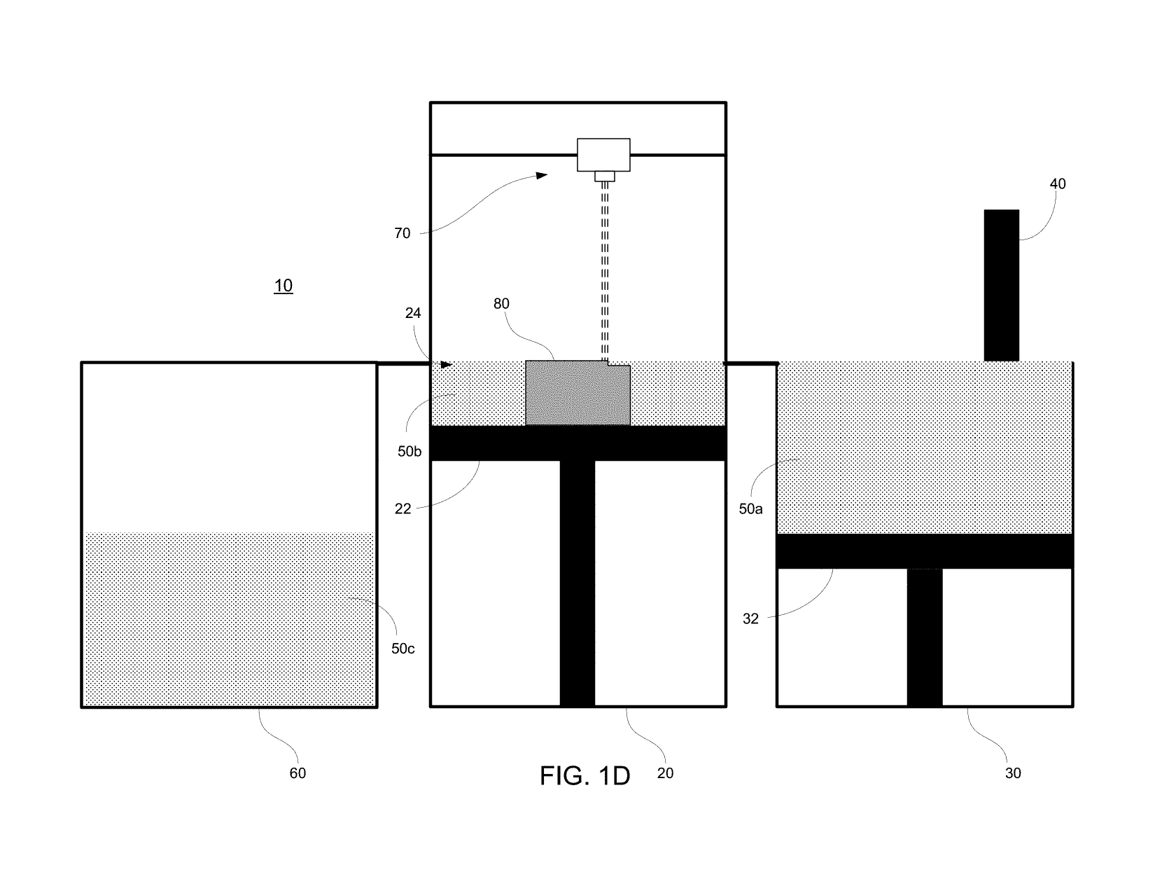

While not intended to be limited to a particular application, embodiments of the invention will be described in the context of typical additive manufacturing (AM) system processes. With reference to FIGS. 1A, 1B, 1C, and 1D, a typical AM system 10 may incorporate a build chamber 20 a feed stock/raw material container 30 and a raw material collection container 60. A build platform or baseplate 22 is disposed within the build chamber 20. The build platform is generally configured to be raised or lowered relative to build chamber 20 and, in particular, relative to a build plane 24. At the start of a build process, the upper surface of the build platform 22 would typically be positioned just below the build plane 24 so that a first layer of the powder material 50b may be disposed on the upper surface. After each layer of powder 50b is deposited and the build layer of the build component 80 is formed, the platform 22 is repositioned to allow deposition of the next layer of powder 50b.

It will be understood by those skilled in the art that while reference is made to a single build component or build part, AM arrangements can be used to build multiple components or parts simultaneously.

The AM manufacturing system 10 has a raw material delivery system configured for transporting a raw powder material 50a from the feedstock container 30 to the build chamber 20 for deposition in the build plane 24. Any suitable material delivery system may be used, but typical such systems will use a deposition device 40 such as a wiper, blade, recoater, roller or the like that pushes or otherwise moves the raw powder 50a from the feedstock container and deposits it uniformly across a predetermined area of the build plane as shown in FIG. 1B. In some systems, the material delivery system may apply powder by blowing or by direct deposition onto the build part 80. The collection chamber 60 is configured to receive and hold unfused feedstock material 50c. This may include excess feedstock from the delivery system and/or powder removed after completion of some or all of the build part 80. While the schematic illustration of system 10 shows the feedstock container 30 and the collection container 60 as being separate from the build chamber, it will be understood that in some cases, the containers 30, 60 may be internal to, attached to or integrally incorporated with the build chamber 20.

The AM manufacturing system 10 also includes an energization apparatus 70 configured to selectively apply energy to and fuse the deposited powder 50b in the build plane according to a predetermined two dimensional pattern appropriate for the particular layer being built. The energization apparatus 70 may include any form of energy delivery appropriate for the particular material being used. Delivery mechanisms may include but are not limited to: lasers, electron beam generators, ultrasonic energy generators, and plasma generators. AM Manufacturing systems may also use arc thermal metal spraying (ATMS), ion beam techniques plating (e.g., electrolytic), cladding case hardening dip/galvanizing, chemical/physical vapor deposition plating (e.g., electrolytic), cold-spray, and/or other general forms of metal, composite, and/or hybrid deposition processes.

The AM manufacturing system 10 may also include a central data processing and control system (not shown). The central data processing and control system will typically include one or more digital data processors in communication with the energization apparatus and actuators for the build platform and the deposition device. The central data processing and control system may also be in communication with sensors configured for monitoring conditions within the build chamber and/or sensors configured for monitoring or selectively measuring conditions on or within the build part.

It will be understood that the central data processing and control system may be in the form of a computer or computer system. The term “computer system” or “operating system” is to be understood to include at least one processor utilizing a memory or memories. The memory stores at least portions of an executable program code at one time or another during operation of the processor. In addition, the processor executes various instructions included in that executable program code. An executable program code means a program in machine language or other language that is able to run in a particular computer system environment to perform a particular task. The executable program code process data in response to commands by a user. As used herein, the terms “executable program code” and “software” are substantially equivalent.

It should also be appreciated that to practice the systems and methods of the invention, it is not necessary that the processor, or portions of the processor, and/or the memory, or portions of the memory be physically located in the same place or co-located with the AM apparatus. Each of the processor and the memory may be located in geographically distinct locations and connected so as to communicate in any suitable manner, such as over a wireless communication path, for example. Each of the processor and/or the memory may also be composed of different physical pieces of equipment. It is not necessary that the processor be one single piece of equipment in one location and that the memory be another single piece of equipment in another location. The processor may be two pieces of equipment in two different physical locations connected in any suitable manner. Additionally, each respective portion of the memory described above may include two or more portions of memory in two or more physical locations, including or utilizing memory stores from the Internet, an Intranet, an Extranet, a LAN, a WAN or some other source or over some other network, as may be necessary or desired.

In a typical AM process, the build platform 22 is raised or lowered so as to position the upper surface of the platform 22 or the most recently deposited layer of powder 50b (and most recently formed layer of the build part 80) just below the build plane 24 as shown in FIG. 1A. The feedstock material delivery system is then used to transfer feedstock material 50a to the build chamber 20 as shown in FIGS. 1B and 1C. The energization apparatus 70 is then used to apply energy to the deposited powder 50b in the build plane 24 according to the predetermined two dimensional pattern appropriate for the current layer of the build part (or parts) 80 as shown in FIG. 1D. The process is then repeated until the build part 80 is complete. Upon completion, the unfused raw material may be removed transferred from the build chamber 20 to the collection container 60 for possible reuse and the completed build part 80 removed for inspection.

The methods of the present invention provide for the use of a directed energy input device (or plurality of devices) to perform individual or bulk layer in-situ microforming of build parts during the additive manufacturing process. More specifically, the present invention allows the performance of microforming operations after (or as) each build part layer is fused. In some embodiments, the methods of the invention may further include in-situ modification of the topology of the build part through the addition of controlled residual stress patterns. The resulting microstructural realignment can provide other benefits associated with material formation of the additively manufactured part (in-process or complete).

As used herein, the term “microforming” means the forming or alteration of structures or geometric features with at least two dimensions in the sub-millimeter range. In-situ microforming methods of the present invention can be performed in a variety of AM machine types (e.g., laser powder bed, directed energy deposition, ultrasonic, etc.) and are considered to have application to all AM processes. The systems and methods of the invention use a directed energy input device or devices (e.g., lasers) in conjunction with a traditional AM system like those described above. The invention applies directed energy material processing (DEMP) methods such as (but not limited to) surface modification (SM) and/or shock peening (SP) to initiate thermal forming (microforming) techniques. DEMP methods can be used to control, alter, modify, or shape additive manufactured parts on a layer-by-layer (or bulk layer basis) in-situ within the build chamber of a typical AM system. The process may also be extended to allow a greater impartation of energy to the substrate (e.g., material being processed) which can controllably alter the microstructural alignment of the material. The result of the microforming application is to change the shape of the microscale structure of the additive layer(s). Additional benefits may include: material longevity under cyclic loading (e.g., fatigue), enhanced overall maximum loading by pre-conditioning, and/or increases in corrosion resistance.

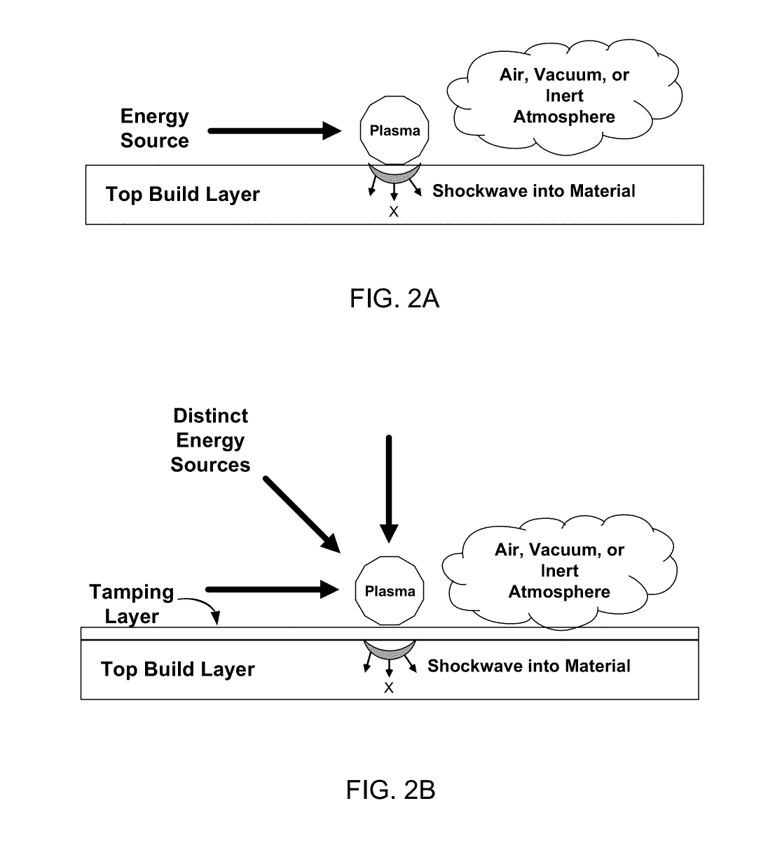

FIGS. 2-4 illustrate the effects of DEMP when applied to a build part. As shown in FIGS. 2A and 2B, both DEMP approaches (i.e., SM and SP) effect micro-structural changes in the material by using one or more directed energy sources (e.g., lasers) to generate a plasma plume at the surface of the top-most build layer. Such a plume will occur at the surface of either a fused layer (i.e., a layer of fused build material) or one or more layers of unfused build material (e.g., powder or other feedstock material), and may include the process gas. The resultant energy input imparts a short duration (typically nanoseconds) pulse on the surface of the additive layer that causes a strong compressive shock wave that induces compressive forces into the part or part layer, thereby shaping a part layer or layers (e.g., counteracting residual stresses that may tend to pull parts off of build plates, deform geometry, affect precision, alter surface profile, etc.).

Typically, prior art DEMP methods require the use of a tamping layer over the surface of the target material. The tamping layer is used to constrain the shock wave generated by the plasma plume and direct the force into the material. In the context of the present invention, however, it has been found that with the right parameters, a traditional tamping layer is not necessary to generate the desired results. Thus, in either the SM or the SP approach, the process may be conducted without a traditional liquid phase tamping layer. In some embodiments, however, a layer of the build material powder or all or a portion of a previously fused layer or layers may be used for tamping.

In-situ microforming (e.g., via lasers or other directed energy input) can utilize a variety of settings and patterns to create various compressive conditions and/or microstructural conditions in the part. This includes but is not limited to pulsed energy input using a variety of raster patterns coincident with AM or other modifications to the AM process. This approach further considers fabrication variables such as part placement, temperature, and orientation to apply targeted application of this method. The frequency of the directed energy shot, duration, repetitive passes, and other processing variables can be selected so as to selectively and controllably influence microformation of and/or micro-structural re-alignment for a given layer (or layers). Application of correction factors resulting from operating conditions (e.g., inert gas, vacuum, temperature, material, material variation, localized stresses, atmospheric contaminants, ambient environment, initial conditions, material type, tomography, etc.) are considered in this method.

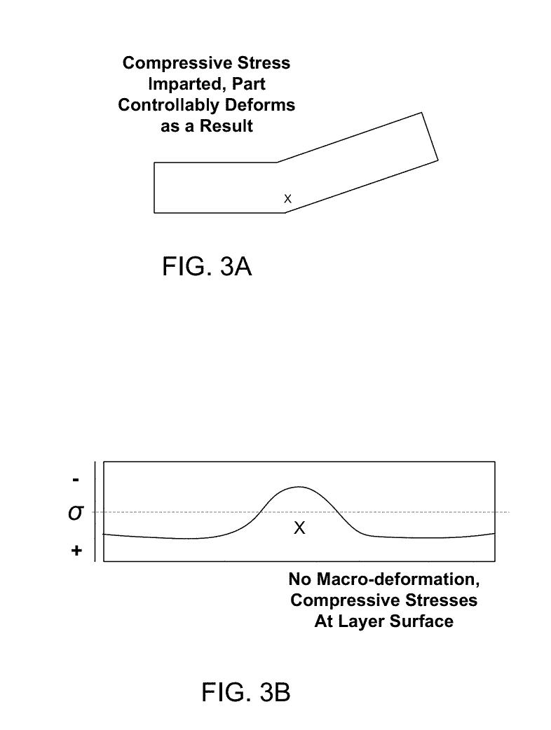

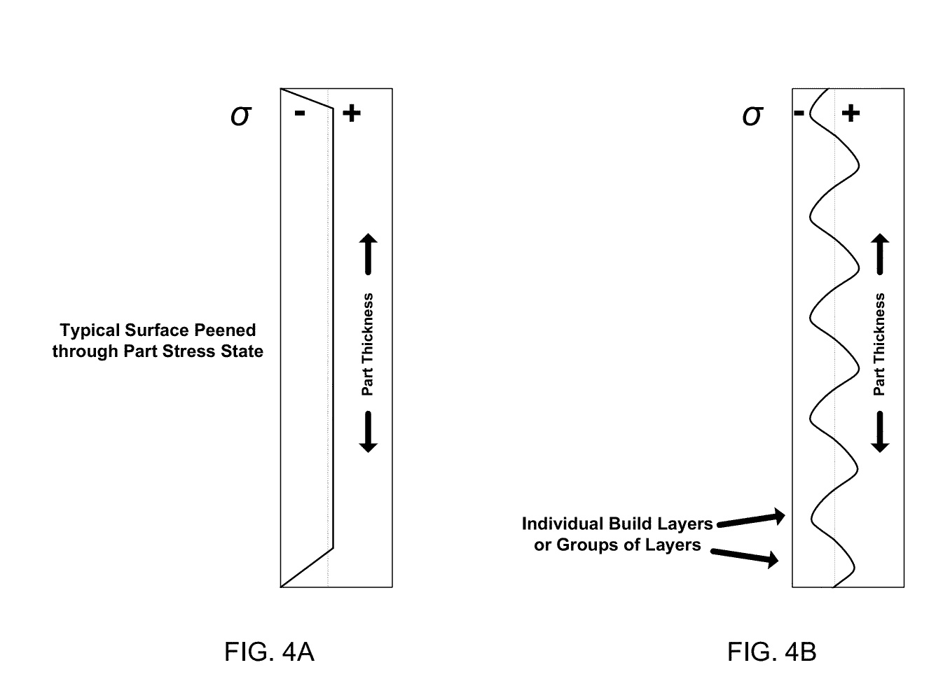

The methods of the invention allow formation of AM components with optimally designed material properties. As illustrated in FIGS. 3 and 4, energy levels and area of application can be tailored to produce desired deformation or internal stress profile. In traditionally manufactured metal components only the surfaces can be influenced by the effect of SM or SP, as illustrated in FIG. 4A. However, when incorporated into an AM build process, each layer of the component can be influenced by the effects of DEMP (i.e., SM/SP), as illustrated by FIG. 4B. Influencing the internal stress state of a component layer-by-layer allows the component's geometry and/or material properties to be altered at a much finer level than when performed on the bulk part. The methods of the invention also allow the determination of the resulting mechanical and microstructural properties of the manufactured product. Additionally, due to the potential resulting surface conditions (e.g., roughness) imparted as part of this process, microforming may have other added benefits (e.g., better adhesion/fusion of layers in a single, or multi-material applications).

In the methods of the invention, the appropriate energy input may be determined based on material, component design, energy input orientation, energy input location, energy input characteristics (wavelength, power, pulse width, etc.), transverse speed (i.e., translational speed of the energization device), intended results, temperature, operating environment, simulated residual stress, and other factors. Analysis can also be performed using topology scans taken after each layer (ply) of the AM process is completed. In some embodiments, adjustments may be determined based on information obtained using in-situ magneto-inductive testing methods such as those described in U.S. patent application Ser. No. 15/587,003, filed May 4, 2017, the complete disclosure of which is incorporated herein by reference.

Based on application of the DEMP methods, the depth of penetration of the compressive wave is understood from previous research. This, along with known layer depth, allows the use of computational algorithms to determine when the process is to be initiated. Laser scanning topology can further augment this process control as another potential variant. This method further includes a variant that encompasses the in-process visualization (possibly real-time or simulated) to support in-situ build quality monitoring of the process. This method may require the user to test or understand the microforming capabilities for a given material and/or part considering variables such as: operational wavelengths, beam powers, critical bubble size, critical radius, temperature (e.g., saturation, critical, etc.), liquid and/or vapor pressures, time, etc.

The methods of the invention can be used for, inter alia,
1) Making physical part modifications on a part layer (or layers) basis;
2) Supporting in-situ build quality monitoring or closed-loop-control adjustment of additively manufactured parts on a layer-by-layer (or n layers-by-n layers) basis;
3) In-situ defect correction of AM parts/material using microforming techniques (e.g., SP and/or SM methods);
4) Altering material properties for either the bulk component, select layers and/or select component areas;
5) Microstructural re-alignment of the produced topology and/or microstructure;
6) In-situ surface finish alteration of a given part;
7) In-situ or post processing material removal (e.g., part material or support structure);
8) AM layer post processing; and
9) In situ preprocessing (i.e., prior to AM energization)

As suggested above, the DEMP systems of the invention can be used to preprocess a layer (or layers) of build material powder prior to the energization used to fuse the material. This could be done for the purpose of pre-heating or altering the temperature of the powder prior to AM processing. This may allow a reduction in the amount of direct energy needed to fuse the material. The effect may be to lower the amount of energy applied by the system and a consequent reduction in the thermal gradients that produce process-induced stresses. Preprocessing may also be used for “compacting” of the raw material (e.g., powder) prior to fusing.

In some cases, the build material powder may be a mixture of multiple materials. In such cases, DEMP preprocessing may be used to premelt one or more of the constituent alloys, prior to the AM process melting and fusing the entire mixture. Depending on the process conditions, this can allow the development of different alloying ratios in different regions of the part.

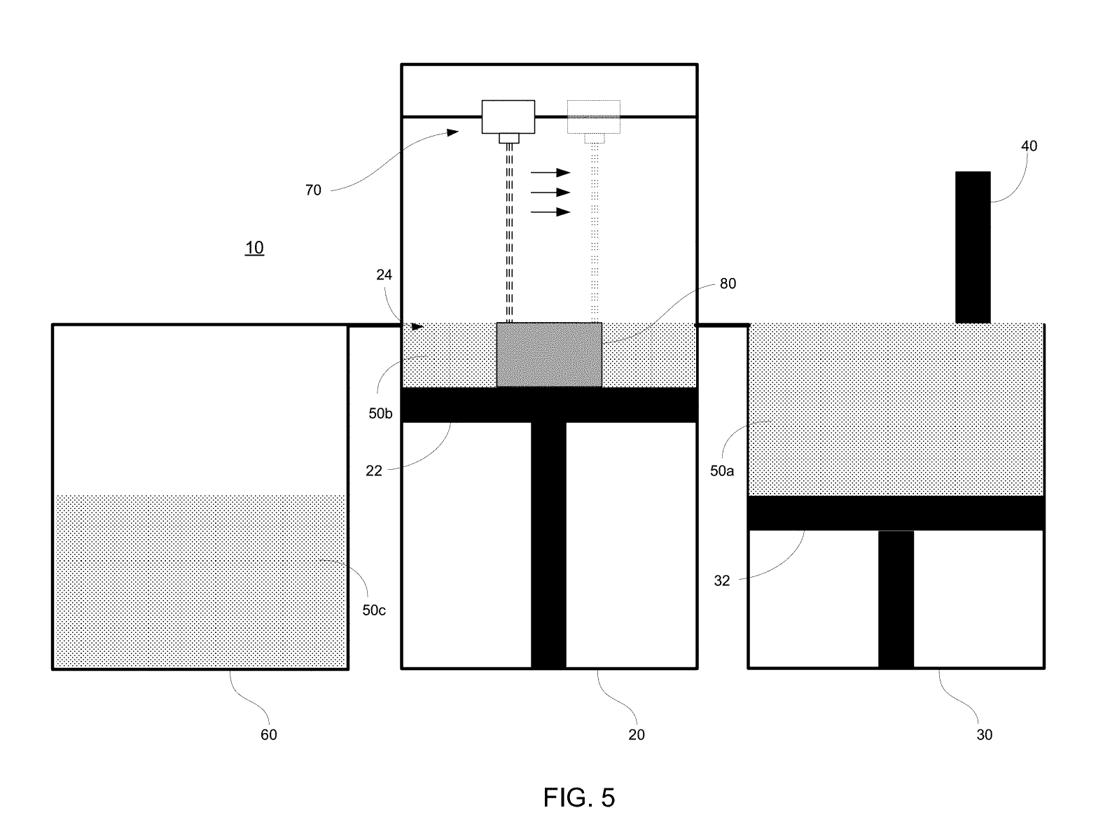

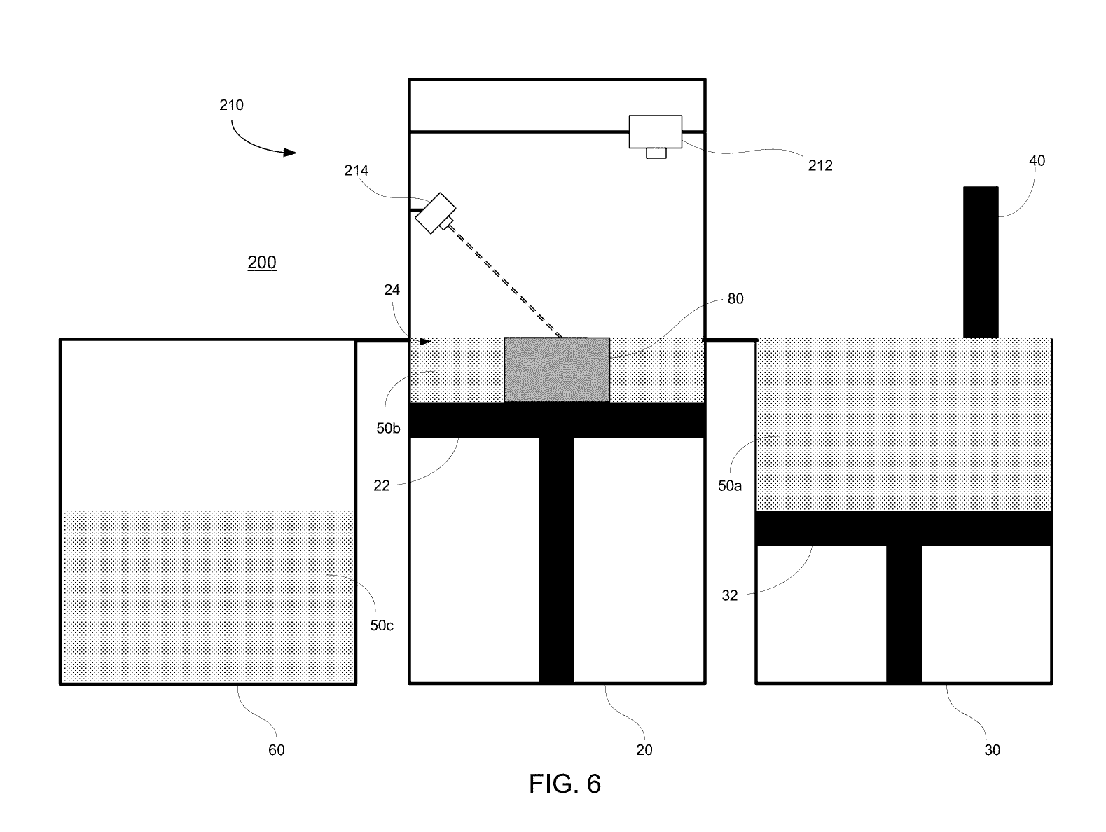

The methods of the invention may be implemented with directed energy input devices incorporated into typical AM systems. In some embodiments, the DEMP processes used in the methods of the invention may be implemented using the same energization device used in the AM process. As illustrated in FIG. 5, for example, the energization apparatus 70 of AM system 10 may be configured to carry out DEMP (e.g., SP and/or SM) on a fused build layer in the build plane 24. In this approach, the energization apparatus 70 may be passed over the surface one or more additional times after having completed its AM fusion pass(es) in order to carry out microforming operations on the surface of the build part 80.

FIG. 6 illustrates an integrated AM/material processing system 200 having an energization arrangement 210 that includes a fusion energization source 212 and a separately controlled and manipulated material processing energization source 214. The fusion energization source 212 may be any laser or other directed energy device suitable for fusing a layer of build material 50 to form a portion of a build part 80. The material processing energization source 214 may be any laser or directed energy device configurable to carry out micro-level processing operations, including shock peening, micro-structural modification, and surface modification processes. It will be understood that the material processing energization source 214 may be the delivery portion of a larger directed energy apparatus, some of which is disposed outside of the build chamber 20.

In particular embodiments, the material processing energization source 214 is a laser (or the delivery mechanism for a laser) configured for carrying out laser shock peening (LSP) and/or laser surface modification (LSM) processes on the surface of the build part 80 after fusion of the latest build layer by the fusion energization source 212. In some embodiments, the material processing energization source 214 may also be used to preprocess a layer of powder deposited on the build platform 22 or the surface of the build part 80 prior to application of fusing energy by the fusion energization source 212. The material processing energization source 214 may be attached to or integrated into a wall of the build chamber 20 and may be configured to translate and/or rotate to change the device's angle of incidence and/or to assure surface coverage of any build part formed in the chamber 20.

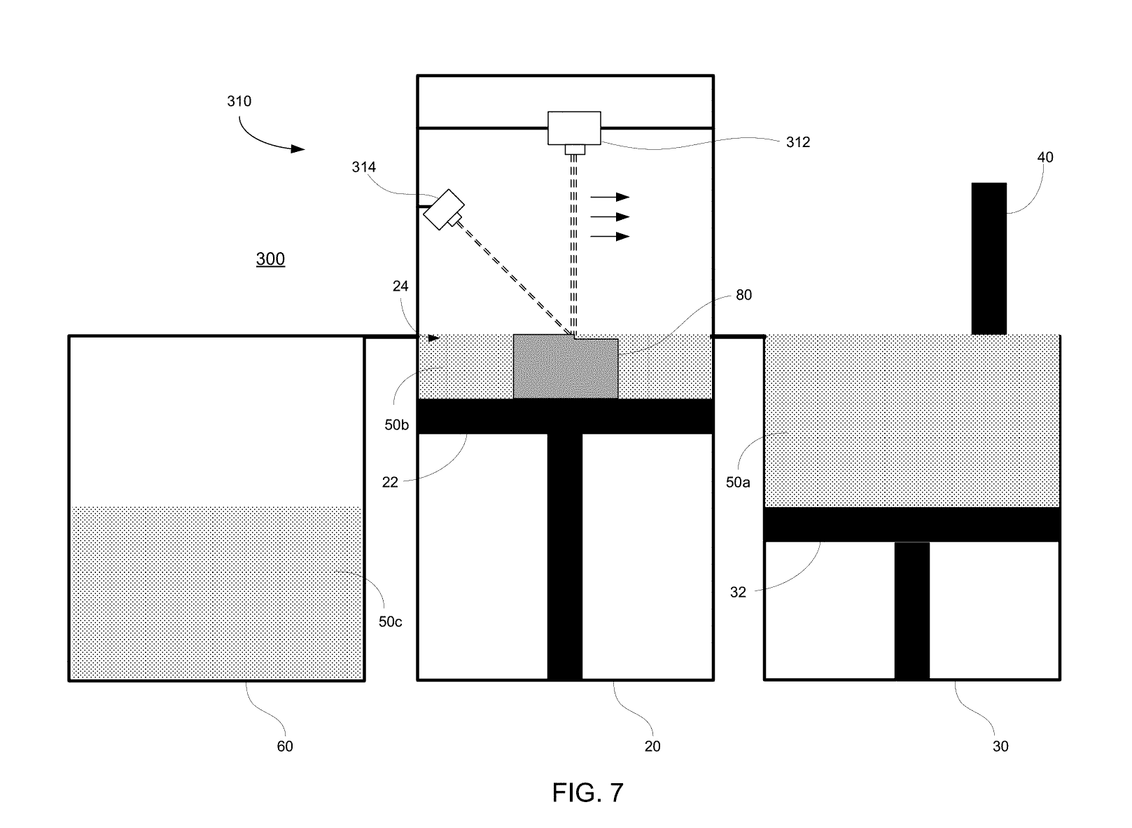

FIG. 7 illustrates an integrated AM/material processing system 300 having an energization arrangement 310 that includes a fusion energization source 312 and a separately controlled and manipulated material processing energization source 314 that is configured for working cooperatively with the fusion energization source 312. The fusion energization source 312 may be any laser or other directed energy device suitable for fusing a layer of build material 50 to form a portion of a build part 80. The material processing energization source 314 may be any laser or directed energy device configurable to carry out micro-level processing operations, including shock peening, micro-structural modification, and surface modification processes. It will be understood that the material processing energization source 314 may be the delivery portion of a larger directed energy apparatus, some of which is disposed outside of the build chamber 20. In particular embodiments, the material processing energization source 314 is a laser (or the delivery mechanism for a laser) configured for carrying out LSP and/or LSM processes on the surface of the build part 80. The material processing energization source 314 may be controlled in a manner so that it carries out DEMP processing either immediately after (or immediately before) fusion of the build material by the fusion energization source 312. The material processing energization source 314 may be attached to or integrated into a wall of the build chamber 20 and may be configured to translate and/or rotate to change the device's angle of incidence and/or to assure surface coverage of any build part formed in the chamber 20.

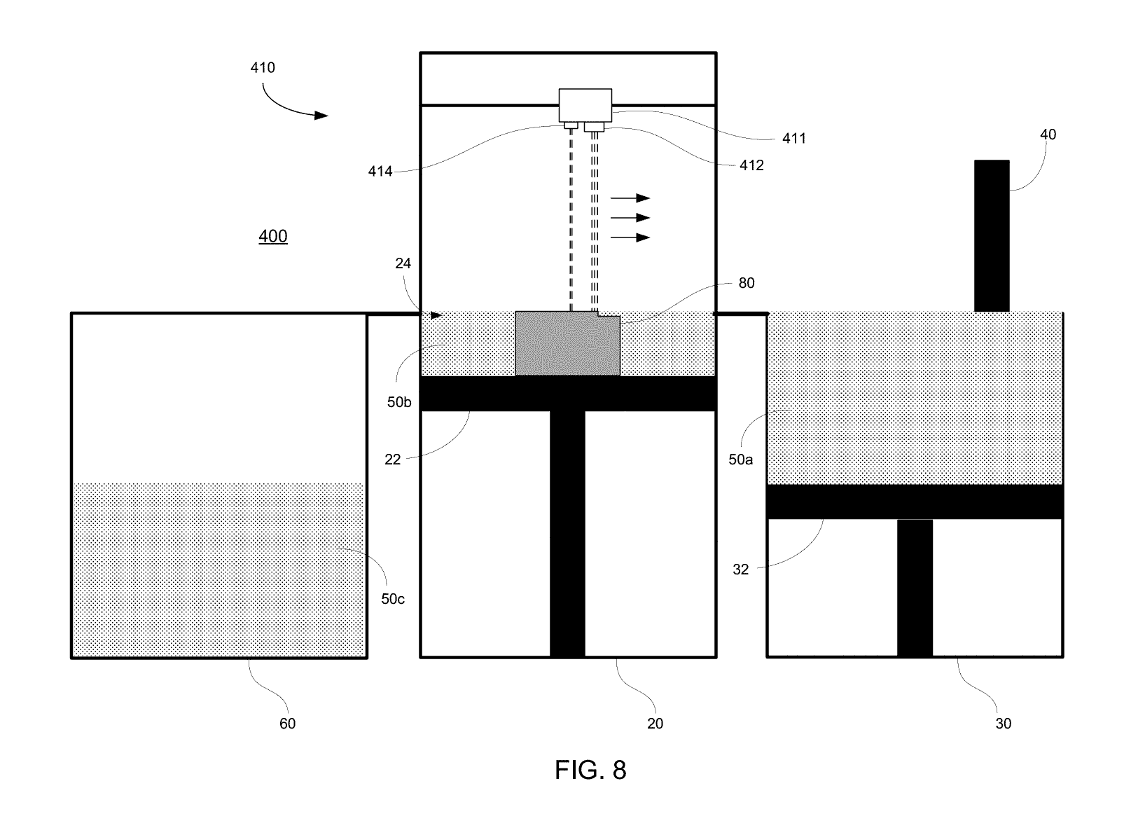

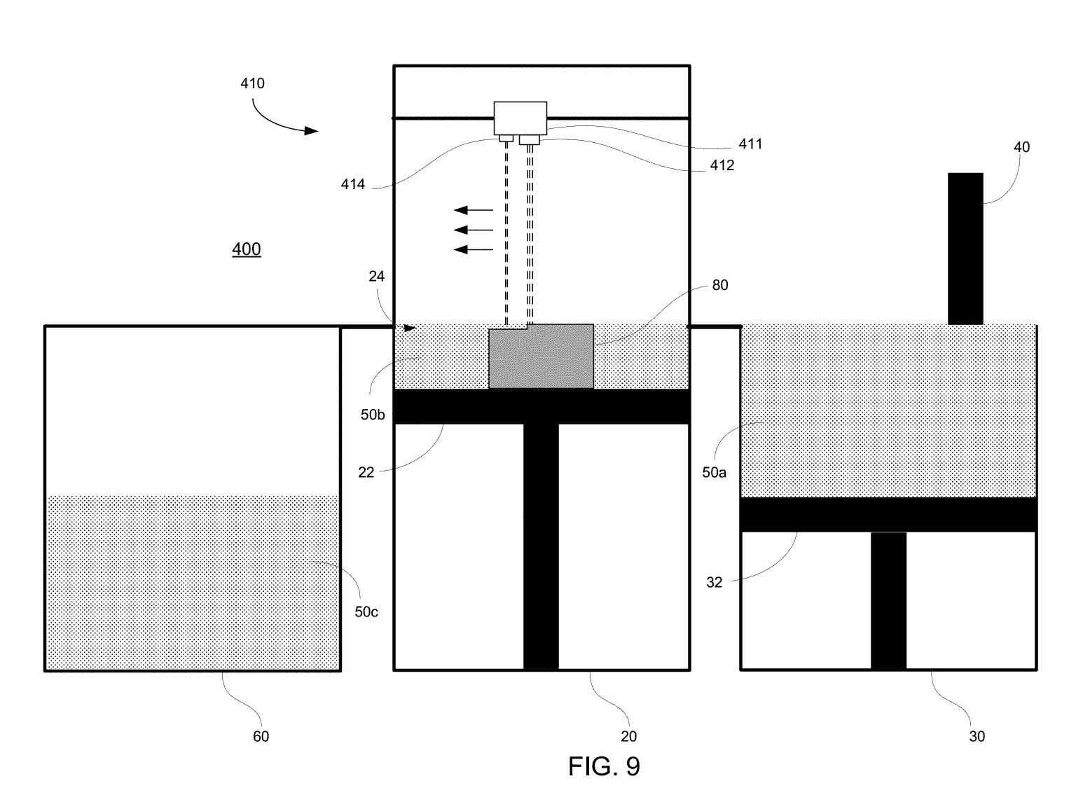

FIGS. 8 and 9 illustrate an integrated AM/material processing system 400 having an energization arrangement 410 that uses a single energization apparatus 411 comprising a fusion energization source 412 and a material processing energization source 414. In some embodiments, the energization apparatus 411 may simply be a combination of a fusion energization source 412 and a material processing energization source 414 coupled together so that they move together within the chamber 20. The fusion energization source 412 may be any laser or other directed energy device suitable for fusing a layer of build material 50 to form a portion of a build part 80. The material processing energization source 414 may be any laser or directed energy device configurable to carry out micro-level processing operations, including shock peening, micro-structural modification, and surface modification processes. It will be understood that the material processing energization source 414 may be the delivery portion of a larger directed energy apparatus, some of which is disposed outside of the build chamber 20. In particular embodiments, the material processing energization source 414 is a laser (or the delivery mechanism for a laser) configured for carrying out LSP and/or LSM processes on the surface of the build part 80. The AM fusing and material processing operations may be conducted by the energization apparatus 410 on a single pass (as shown in FIGS. 8 and 9) or may be conducted on separate passes. In either case, material processing operations may be conducted before or after AM fusing or both before and after AM fusing. FIG. 8 illustrates a single pass operation in which the material processing energization source 414 conducts material processing operations after fusion by the fusion energization source 412, while FIG. 9 illustrates a single pass operation in which the material processing energization source 414 conducts DEMP operations on the powder material prior to fusion by the fusion energization source 412.

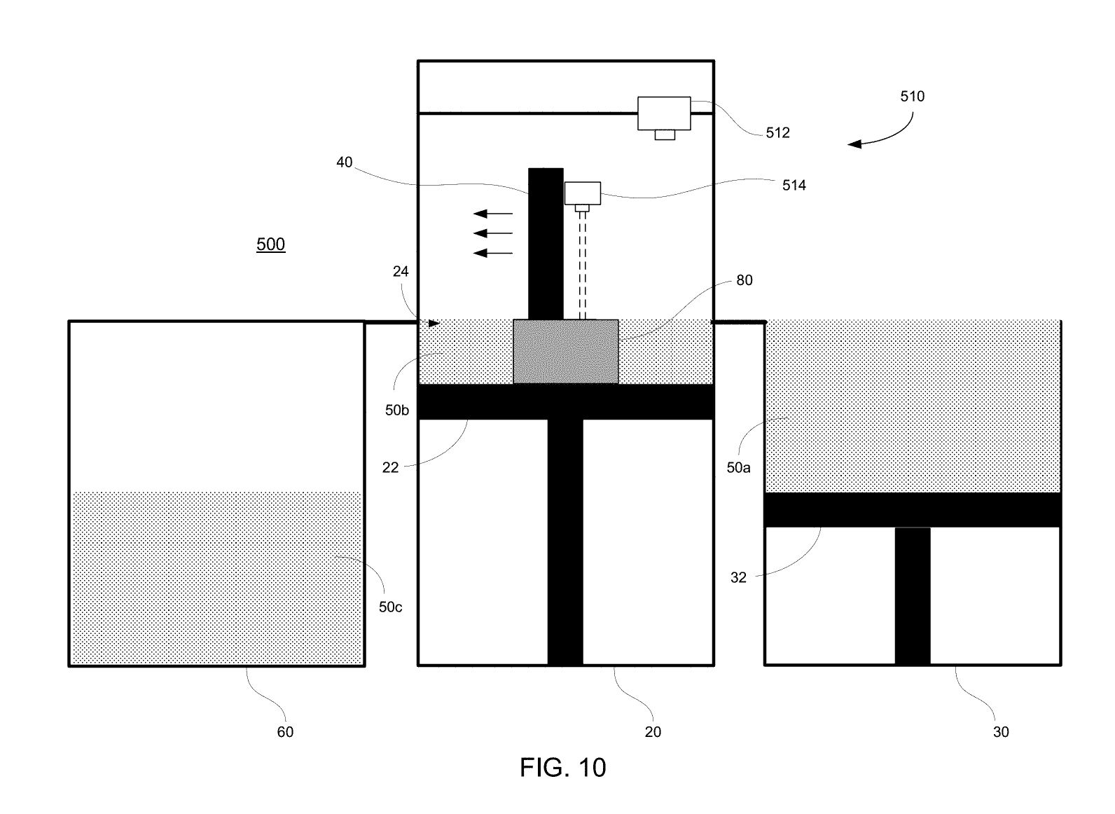

FIG. 10 illustrates an integrated AM/material processing system 500 having an energization arrangement 510 that includes a fusion energization source 512 and a separately controlled material processing energization source 514 that is attached to the deposition device 40. The fusion energization source 512 may be any laser or other directed energy device suitable for fusing a layer of build material 50 to form a portion of a build part 80. The material processing energization source 514 may be any laser or directed energy device configurable to carry out micro-level processing operations, including shock peening, micro-structural modification, and surface modification processes. It will be understood that the material processing energization source 514 may be the delivery portion of a larger directed energy apparatus, some of which is disposed outside of the build chamber 20. In particular embodiments, the material processing energization source 514 is a laser (or the delivery mechanism for a laser) configured for carrying out LSP and/or LSM processes on the surface of the build part 80. As shown in FIG. 7, the deposition device 40 may be passed over a fused layer of the build part 80 to allow the material processing energization source 514 to conduct micro-level processes on the surface of the build part 80. The material processing energization source 514 may also be used to preprocess a layer of powder deposited on the build platform 22 or the surface of the build part 80 prior to application of fusing energy by the fusion energization source 512. This may be accomplished on the same pass of the deposition device 40 used to spread a powder layer over the surface of the build part 80.

Any or all of the foregoing embodiments may include a material processing control and data processing system. This control and data processing system may comprise one or more digital data processing systems that are part of or in communication with an AM control and data processing system. The material processing control and data processing may be in communication with the energization arrangement of the AM/material processing system for transmitting processing operation control signals thereto. The material processing control and data processing may also be in communication with sensor and evaluation systems for determining the effect of material processing operations.

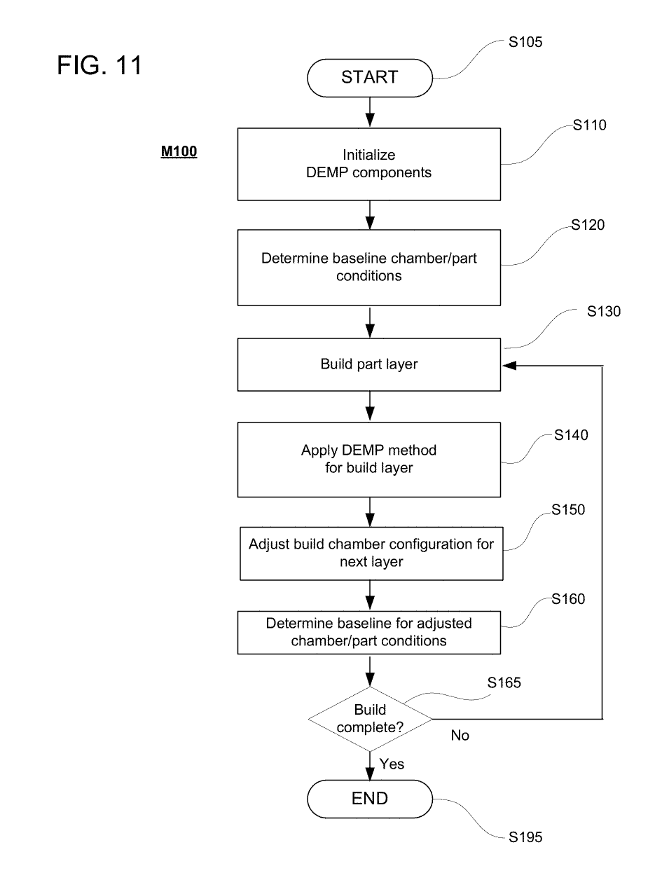

The above-described system configurations may be used to carry out a generalized AM manufacturing process M100 as shown in FIG. 11. The method begins at S105. At S110, the DEMP energization source components (e.g., LMP or other energy source(s), build chamber atmosphere/conditions, etc.) may be initialized. At S120, the baseline chamber and build part conditions may be determined. At S130, raw material feedstock is deposited at the build plane and the AM energization system is activated to fuse the build material in the desired two dimensional pattern to form the first (or latest) layer of the build part. At S140, one or more DEMP energy input devices is/are used to carry out DEMP operations on the fused build layer. At S150, the build platform and chamber are adjusted for construction of the next build layer. In some systems, this will involve positioning (or repositioning) the build platform to position the upper surface of the build part to receive the next layer of raw material. At S160, the baseline conditions for the adjusted platform/chamber configuration and the updated build part are determined. At S165, the AM system determines whether the build part is complete. If it is not, the next layer is built and actions S130-S165 are repeated. If the part is complete, the method ends at S195. It will be understood that the actions S150, S160 may optionally be carried out after the determination is made at S165.

As previously noted, the DEMP operations of the invention may often be conducted without the use of a tamping layer. In some circumstances, however, it has been found that a tamping layer can still be useful to accomplish certain micro-forming operations. In particular, it has been found that in some applications, a layer of raw build material can be used as a tamping layer. Accordingly, in some methods of the invention, DEMP operations may be conducted after the repositioning of the build platform, but before application of the build material for the next layer. A tamping layer of raw material feedstock is then applied on the just-fused build layer and a processing level of directed energy is applied to the build layer through the tamping layer, The level and frequency of the directed energy is selected so as to accomplish the tamped micro-processing of the build layer (e.g., via SP) without fusing the build material. Once the DEMP operations are completed, the method continues with the regular application of build material for building the next layer of the build part.

It will be understood that the above method may incorporate diagnostic operations to assess the condition/characteristics of the build part after application of the new build layer, but before material processing operations are conducted. Information from these diagnostic operation may be used to make adjustments to the material processing operations. These adjustments can be configured to make corrections in the structure or to take the as-built structure into account when microforming to establish the desired internal stress profile, geometry and/or material properties.

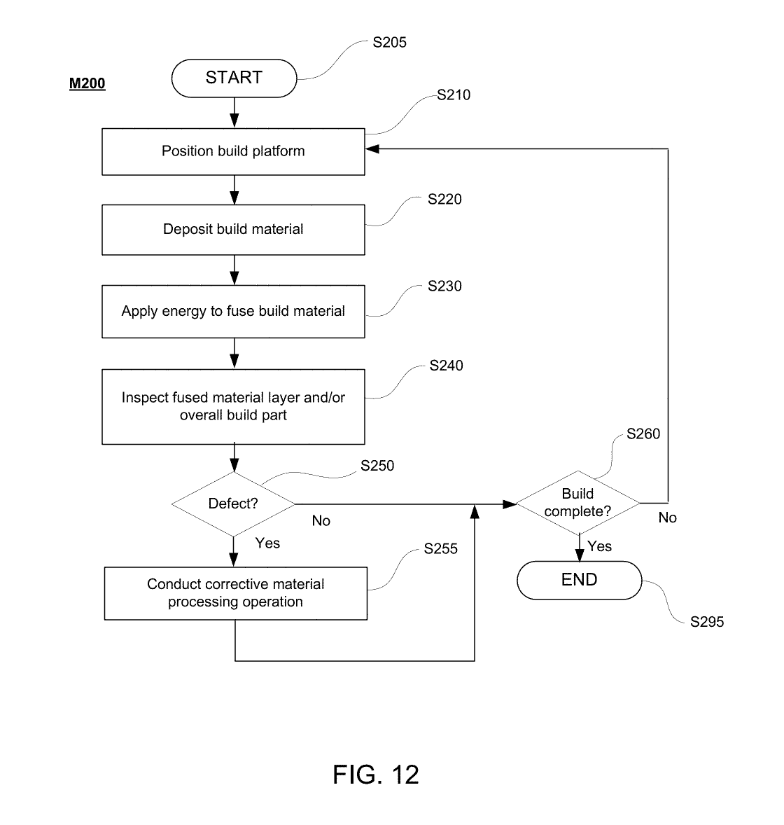

FIG. 12 depicts an illustrative AM manufacturing process M200 in which material processing operations are effected in response to diagnostic inspection results. The method begins at S205. As in the previous method, the energization components may be initialized and chamber and build part conditions may be determined prior to initiation of the build sequence. At S210, the build platform is positioned so that the surface to which the next build layer is to be applied is positioned at the build plane. At S220, raw material feedstock is deposited at the build plane. At S230 the AM fusion energization source is activated to apply energy to the build material and fuse the material in the desired two dimensional pattern to form the first (or latest) layer of the build part. At S240, an in-situ diagnostic inspection of the fused layer and/or all or a predetermined portion of the entire build part is conducted. The results are used at S250 to determine if an undesirable condition (defect) is present therein. This inspection may include a topology scan or magneto induction testing and analysis (e.g., complex impedance plane analysis). Undesirable conditions may include, for example, micro-structural geometry anomalies, undesired material properties, and undesired stress profiles. If an undesirable condition is identified, a corrective material processing operation is conducted at S255 using one or more material processing energization sources. This may include determination of the appropriate corrective operation type, energization levels and frequencies, and target location(s) and/or pattern(s) on the surface of the build part. The corrective operation may include an SM energy application, an MP energy application, or both. After the corrective operation is conducted, or if no undesirable condition is identified, the method passes to S260 where a determination is made as to whether the build part is complete. If it is, the method ends at S295. If it is not, the method returns to S210 and the process steps for building and inspecting a new build part layer (S210-S255) are repeated.

Although not shown in FIG. 12, upon completion of the corrective material processing operation at S255, the method M200 may include repeating actions S240 and S250 to determine the effectiveness of the corrective operation. This repetition may be continued until a desired state is achieved.

It will be understood that the methods of the invention may be used in conjunction with any form of AM process using any build material. Further, it will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

What is claimed is:

1. An additive manufacturing apparatus comprising:
a build chamber;
a build platform disposed within the build chamber for supporting an AM build part therein, the build platform being movable along a vertical axis to allow sequential positioning of the AM build part to position a surface of a last-produced layer of the AM build part at a horizontal build plane for addition of a next-to-be-produced layer thereto;
a build material deposition device configured for applying a layer of build material to the surface of a last-produced layer of the AM build part;
an energization arrangement having at least one energization source, the energization arrangement being capable of,
in a fusion energy operation, selectively applying energy to the layer of build material to fuse the build material to form the next-to-be-produced layer and,
in a material processing operation, selectively applying energy to and processing at least one of the set consisting of the surface of a last-produced layer of the AM build part, the layer of build material, and a surface of the next-to-be-produced layer.

2. An additive manufacturing apparatus according to claim 1 wherein the at least one energization source comprises a single source capable of applying energy in both a fusion energy operation and a material processing operation.

3. An additive manufacturing apparatus according to claim 1 wherein the at least one energization source comprises a fusion energization source capable of applying energy in a fusion energy operation and a processing energization source capable of applying energy in a material processing operation.

4. An additive manufacturing apparatus according to claim 3 wherein the processing energization source is configured for application of at least one of the set consisting of laser surface modification and laser shock peening at one or more predetermined locations on the surface of a last-produced layer of the AM build part.

5. An additive manufacturing apparatus according to claim 3 wherein the fusion energization source and processing energization source are configurable to conduct a first sequential operation in which the fusion energization source applies energy to a portion of the layer of build material to fuse the build material, thereby forming a portion of the next-to-be-produced layer, and the processing energization source then applies energy to the portion of the next-to-be produced layer to effect a desired processing result.

6. An additive manufacturing apparatus according to claim 3 wherein the fusion energization source and processing energization source are configurable to conduct a second sequential operation in which the processing energization source applies energy to a portion of the layer of build material and then the fusion energization source applies energy to the portion of the layer of build material to fuse the build material, thereby forming a portion of the next-to-be-produced layer.

7. An additive manufacturing apparatus according to claim 3 wherein the processing energization source is attached to or integrated into an interior wall of the build chamber.

8. An additive manufacturing apparatus according to claim 3 wherein the fusion energization source and the processing energization source are coupled for joint movement within the build chamber.

9. An additive manufacturing apparatus according to claim 3 wherein the processing energization source is coupled to the build material deposition device for joint movement therewith.

10. An additive manufacturing apparatus according to claim 3 wherein the processing energization source comprises a material processing laser.

11. A method of manufacturing an additive manufacturing (AM) build part using an AM apparatus comprising a build chamber, a build platform, a fusion energization source configured for fusing a build material at a horizontal build plane within the build chamber, and a processing energization source, the method comprising:
positioning an upper surface of the build platform at the build plane;
depositing a layer of the build material at the build plane;
applying energy by the fusion energization source to fuse a portion of the build material in a desired pattern to form a current layer of the AM build part; and
effecting a material processing operation on the current layer of the AM build part by using the processing energization source to apply energy to a surface of the current layer of the AM build part.

12. A method according to claim 11 further comprising:
determining whether a next build part layer should be constructed; and
responsive to a determination that a next build part layer should be constructed, repositioning the build platform to position an upper surface of the current layer at the build plane and repeating the actions of depositing, applying, effecting, and determining.

13. A method according to claim 11 wherein the material processing operation is a microforming operation.

14. A method according to claim 11 wherein the material processing operation comprises at least one of the set consisting of laser surface modification and laser shock peening.

15. A method according to claim 11 wherein the processing energization source comprises a material processing laser.

16. A method according to claim 11 wherein the material processing operation is tailored for modification of at least a portion of a structural geometry of the current build layer.

17. A method according to claim 16 wherein the material processing operation is a microstructural realignment.

18. A method according to claim 16 wherein the material processing operation is effected to correct a structural defect.

19. A method according to claim 16 wherein the material processing operation includes removing material from the AM build part.

20. A method according to claim 11 wherein the material processing operation is tailored for modification of a material property of one of the set consisting of the overall AM build part, a predetermined portion of the AM build part, and the current build layer.

21. A method according to claim 11 wherein the material processing operation is tailored for establishing a desired stress profile within at least one of the set consisting of the current build layer, a predetermined plurality of build layers, and the overall build part.

22. A method according to claim 11 further comprising:
prior to the action of applying energy by the fusion energization source, applying energy to the build material using the material processing energization source, thereby effecting a desired pre-fusion condition in the build material.

23. A method according to claim 11 further comprising:
prior to the action of effecting a material processing operation,
repositioning the build platform to position an upper surface of the current layer at the build plane; and
depositing a tamping layer of the build material at the build plane.

24. A method of manufacturing an additive manufacturing (AM) build part using an AM apparatus comprising a build chamber, a build platform, a fusion energization source configured for fusing a build material at a horizontal build plane within the build chamber, and a processing energization source, the method comprising:
positioning an upper surface of the build platform at the build plane;
depositing a layer of the build material at the build plane;
applying energy by the fusion energization source to fuse a portion of the build material in a desired pattern to form a current layer of the AM build part;
inspecting the current layer of the AM build part to identify undesirable conditions;
responsive to identification of an undesirable condition,
effecting a corrective material processing operation on the current layer of the AM build part using the processing energization source;
determining whether a next build part layer should be constructed; and
responsive to a determination that a next build part layer should be constructed, lowering the build platform to position an upper surface of the current layer at the build plane and repeating the actions of depositing, applying, inspecting, effecting responsive to identification of an undesirable condition, and determining.

25. A method according to claim 24 wherein the corrective material processing operation is a microforming operation.

26. A method according to claim 24 wherein the corrective material processing operation comprises at least one of the set consisting of surface modification and shock peening.

27. A method according to claim 24 wherein the processing energization source comprises a material processing laser.
